(19) United States
(12) Patent Application Publication
(10) Pub. No.: US 2021/0398030 A1
(43) Pub. Date: Dec. 23, 2021

(54) RESERVATION SUBSTITUTE REMITTANCE METHOD USING RESERVATION SUBSTITUTE REMITTANCE PROCESSING SERVER AND SYSTEM USING THE SAME

(71) Applicant: Spinor Media Inc., Seoul (KR)

(72) Inventor: Zae Young KIM, Seoul (KR)

(73) Assignee: Spinor Media Inc., Seoul (KR)

(21) Appl. No.: 17/336,409

(22) Filed: Jun. 2, 2021

(30) Foreign Application Priority Data
Jun. 18, 2020 (KR) 10-2020-0074071

(51) Int. Cl. G06Q 10/02

(52) U.S. Cl. CPC G06Q 10/02

(57) ABSTRACT

A reservation substitute remittance method using a reservation substitute remittance processing server is provided. The method includes receiving a request from at least one of a remitter and a substitute remitter to generate a reservation substitute remittance unit; generating the reservation substitute remittance unit based on identification information of the remitter and the substitute remitter; receiving a remittance or payment request from the remitter; processing a substitute remittance or a substitute payment based on a remittable amount of the reservation substitute remittance unit; and reflecting results of processing the substitute remittance or the substitute payment to the reservation substitute remittance unit.

### CROSS REFERENCE TO RELATED APPLICATIONS

This application claims priority to Korean Patent Application No. 10-2020-0074071 filed on Jun. 18, 2020, the entire contents of which are herein incorporated by reference.

### TECHNICAL FIELD

The present disclosure relates to a reservation substitute remittance method using a reservation substitute remittance processing server and a system using the same, and particularly to, a method and system for generating a reservation substitute remittance unit by using remittable amount and remittable time information, and efficiently managing and processing substitute payment funds.

### BACKGROUND ART

A payment method developed in the past wired communication technology era is a seller payment method, in which a buyer first specified the payment method and delivered buyer information to a seller. In this case, there are problems that the risk of exposure of the buyer information increases, and inconsistency between a payment information flow and a cash flow occurs compared to a normal transaction.

A reverse payment method that solves these problems is a method that has evolved into a wireless mobile payment method due to the recent development of wireless communication technology and popularization of mobile devices, and delivers seller information to the buyer. At this time, the risk of exposure of the buyer information is reduced, and the payment information flow and the cash flow coincide with the normal transaction, and, that is, after the buyer receives and confirms payment related information, the funds are executed.

In the case of such reverse payment or remittance, when the buyer lacks the ability to directly pay or remit, there occurs a case where purchase funds must be raised from a substitute payer or a substitute remitter. In the case of substitute payment/remittance, the buyer wants to increase convenience by issuing reservation substitute payment/remittance amount in advance without limitation of a place of purchase or a recipient before the substitute payment/remittance is made. Meanwhile, in the case of the substitute payer/remitter, the efficient and systematic management of the funds may be possible if the required amount is processed at the time when the substitute payment/remittance is required without having to remit the payment funds in advance.

Therefore, there is a need for a new method and system for reservation substitute remittance/payment processing reflecting such a demand.

### PRIOR ART DOCUMENT

### Patent Literature 1

Korean Patent No. 10-2017254

### SUMMARY

### Technical Problem

The present disclosure is directed to providing a reservation substitute remittance method and system using a reservation substitute remittance processing server configured to generate and issue a reservation substitute remittance unit by using remittable amount and remittable time information.

The present disclosure is also directed to providing a reservation substitute remittance method and system, which increase the convenience of a user (a remitter) because it is not necessary to know a recipient or a place of purchase in advance when issuing a reservation substitute remittance unit, and which are capable of efficiently and systematically managing substitute remittance funds by processing substitute remittance/payment at a future time when a remittance or payment is required.

The present disclosure is also directed to providing a reservation substitute remittance method and system, which do not require multiple substitute remittance processing and may reduce a transfer fee through an efficient remittance/collection management by integrating and managing a plurality of reservation substitute remittance units.

The present disclosure is also directed to providing a family finance integration platform which expands a family finance communication range between family members, manages family finances efficiently, and is also available for gift and inheritance.

The problems to be solved of the present disclosure are not limited to the description mentioned above, and other technical problems that are not mentioned will be clearly understood by those skilled in the art from the following description.

### Technical Solution

In one aspect of the present disclosure, there is provided a reservation substitute remittance method using a reservation substitute remittance processing server including receiving a request from at least one of a remitter and a substitute remitter to generate a reservation substitute remittance unit; generating the reservation substitute remittance unit based on identification information of the remitter and the substitute remitter; receiving a remittance or payment request from the remitter; processing a substitute remittance or a substitute payment based on a remittable amount of the reservation substitute remittance unit; and reflecting results of processing the substitute remittance or the substitute payment to the reservation substitute remittance unit.

The reservation substitute remittance unit may include time period information in which a reservation substitute remittance is allowed.

The reservation substitute remittance unit may include start time condition information in which the reservation substitute remittance starts, and the processing of the substitute remittance or the substitute payment may include determining whether a substitute remittance or substitute payment time satisfies the start time condition information.

The reservation substitute remittance unit may include total budget information in which a reservation substitute remittance is allowed, and the remittable amount of the reservation substitute remittance unit may be obtained by subtracting, from the total budget information, an amount on which the substitute remittance or the substitute payment is processed.

The reservation substitute remittance unit may include a first reservation substitute remittance unit and a second reservation substitute remittance unit, and the reservation substitute remittance method may further include processing the substitute remittance or the substitute payment by combining the first reservation substitute remittance unit and the second reservation substitute remittance unit based on whether substitute remitter information of the first reservation substitute remittance unit and remitter information of the second reservation substitute remittance unit are the same.

The reservation substitute remittance method may further include comparing and determining a substitute remittance or substitute payment time with time period information of the first reservation substitute remittance unit in which a reservation substitute remittance is allowed and time period information of the second reservation substitute remittance unit in which a reservation substitute remittance is allowed.

In another aspect of the present disclosure, there is provided a reservation substitute remittance processing server for processing a reservation substitute remittance including a reservation substitute remittance unit generation portion configured to generate a reservation substitute remittance unit in response to a request from at least one of a remitter and a substitute remitter based on identification information of the remitter and the substitute remitter; a substitute remittance condition processing portion configured to receive a remittance or payment request from the remitter and process a substitute remittance or a substitute payment based on a remittable amount of the reservation substitute remittance unit; and a reservation substitute remittance display processing portion configured to reflect results of processing the substitute remittance or the substitute payment to the reservation substitute remittance unit and provide the reservation substitute remittance unit to a user.

The reservation substitute remittance unit may include time period information in which a reservation substitute remittance is allowed.

The reservation substitute remittance unit may include start time condition information in which the reservation substitute remittance starts, and wherein the substitute remittance condition processing portion is configured to determine whether a substitute remittance or substitute payment time satisfies the start time condition information.

The reservation substitute remittance unit may include total budget information in which a reservation substitute remittance is allowed, and the remittable amount of the reservation substitute remittance unit is obtained by subtracting an amount on which the substitute remittance or the substitute payment is processed from the total budget information.

The reservation substitute remittance unit may include a first reservation substitute remittance unit and a second reservation substitute remittance unit, and the reservation substitute remittance processing server may further include a unit combination processing portion configured to process the substitute remittance or the substitute payment by combining the first reservation substitute remittance unit and the second reservation substitute remittance unit based on whether substitute remitter information of the first reservation substitute remittance unit and remitter information of the second reservation substitute remittance unit are the same.

The unit combination processing portion may be configured to compare and determine a substitute remittance or substitute payment time with time period information of the first reservation substitute remittance unit in which a reservation substitute remittance is allowed and time period information of the second reservation substitute remittance unit in which a reservation substitute remittance is allowed.

### Advantageous Effects

The present disclosure may provide a reservation substitute remittance method and system using a reservation substitute remittance processing server configured to generate and issue a reservation substitute remittance unit by using remittable amount and remittable time information.

The present disclosure may also provide a reservation substitute remittance method and system which increase the convenience of a user (a remitter) because it is not necessary to know a recipient or a place of purchase in advance when issuing a reservation substitute remittance unit, and which are capable of efficiently and systematically managing substitute remittance funds by processing substitute remittance/payment at a future time when a remittance or payment is required.

The present disclosure may also provide a reservation substitute remittance method and system, which do not require multiple substitute remittance processing and may reduce a transfer fee through an efficient remittance/collection management by integrating and managing a plurality of reservation substitute remittance units.

The present disclosure may also provide a family finance integration platform which expands a family finance communication range between family members, manages family finances efficiently, and is also available for gift and inheritance.

The effects of the present disclosure are not limited to the description mentioned above, and other effects not mentioned will be clearly understood by those skilled in the art from the following description.

### BRIEF DESCRIPTION OF DRAWINGS

FIG. 1 is a conceptual diagram showing a configuration of a reservation substitute remittance processing system using a reservation substitute remittance processing server according to an embodiment of the present disclosure.

FIG. 2 is an example diagram illustrating an example of a substitute remittance processed based on a remittable amount and a remittable time according to an embodiment of the present disclosure.

FIG. 3 is a block diagram illustrating a configuration of a reservation substitute remittance processing server according to an embodiment of the present disclosure.

FIG. 4 is a conceptual diagram illustrating a method of processing a reservation substitute remittance/payment according to an embodiment of the present disclosure.

FIG. 5 is a flowchart illustrating a method of processing a reservation substitute remittance according to an embodiment of the present disclosure.

FIGS. 6A to 6H are example diagrams illustrating a processing process in an app for reservation substitute remittance processing according to an embodiment of the present disclosure.

### DETAILED DESCRIPTION OF THE DRAWINGS

The terms used herein are for the purpose of describing embodiments and are not intended to limit the present disclosure. As used herein, the singular forms also are intended to include the plural forms as well, unless the context clearly indicates otherwise.

It will be further understood that the terms “comprises” and/or “comprising,” when used in this specification, specify the presence of stated elements, steps, operations, and/or components, but do not preclude the presence or addition of one or more other elements, steps, operations, and/or components.

In addition, the terms including ordinals such as “first”, “second”, etc. may be used to describe various components, but the components are not limited to these terms. The terms are used only for the purpose of distinguishing one component from another. In addition, in describing the present disclosure, when it is determined that a detailed description of a related known technology may obscure the spirit of the present disclosure, a detailed description thereof will be omitted.

In addition, configuration units shown in the embodiments of the present disclosure are independently illustrated to represent different characteristic functions, and does not mean that each configuration unit includes separate hardware or a single software configuration unit. That is, each configuration unit is listed and described as a respective configuration unit for convenience of description, and at least two configuration units of each configuration unit are combined to form a single configuration unit, or one configuration unit may be divided into a plurality of configuration units to perform a function. Integrated embodiments and separate embodiments of each of the configuration units are also included in the scope of the present disclosure unless departing from the spirit of the present disclosure.

Hereinafter, embodiments of the present disclosure will be described in detail with reference to the accompanying drawings. The configuration of the present disclosure and its effect will be clearly understood through the detailed description below.

FIG. 1 is a conceptual diagram showing a configuration of a reservation substitute remittance processing system using a reservation substitute remittance processing server according to an embodiment of the present disclosure.

Referring to FIG. 1, the reservation substitute remittance processing system may include a reservation substitute remittance processing server 300 for processing a reservation substitute remittance, a remitter A terminal 100, a plurality of substitute remitter B terminals 210 and 220, etc. The reservation substitute remittance processing server 300, the remitter

A terminal 100, and the plurality of substitute remitter B terminals 210 and 220 may communicate with each other through a wired or wireless communication network. Here, a user terminal such as the remitter A terminal 100, the substitute remitter B1 terminal 210, and the substitute remitter B2 terminal 220 may be one of, for example, a smart phone, a tablet computer, a desktop computer, a laptop computer, a notebook, a workstation, a personal digital assistant (PDA), a portable computer, a wireless phone, a mobile phone, an e-book, a portable multimedia player (PMP), a portable game console, a navigation device, a black box, a digital camera, a television, a wearable device, a speech recognition speaker, a smart speaker, and an artificial intelligence (AI) speaker, but is not limited thereto.

The reservation substitute remittance processing server 300 may be configured to generate and issue a reservation substitute remittance unit using remittable amount and remittable time information at a request of a user, such as a remitter or a substitute remitter, and when a remittance or a payment is made by the remitter at a later time when a substitute remittance is possible, to automatically process a substitute payment of the substitute remitter. More specifically, the reservation substitute remittance processing server 300 may be configured to receive a request to generate the reservation substitute remittance unit from at least one of the remitter or the substitute remitter, generate the reservation substitute remittance unit based on identification information of the remitter or the substitute remitter, then, when receiving a remittance or payment request from the remitter, process the substitute remittance or substitute payment based on the remittable amount of the reservation substitute remittance unit, and reflect substitute remittance or substitute payment processing results to the reservation substitute remittance unit.

The reservation substitute remittance processing server 300 may operate in connection with a dedicated app or a software program for processing the reservation substitute remittance and substitute payment, may include a component such as a memory capable of storing instructions or data related to a central processing unit (CPU), an application processor (AP), at least one other component, and, if necessary, access necessary information by communicating with an external memory or a cloud server.

Here, the remitter is a person who receives the benefit of remittance or payment, such as purchasing goods including products, items, services, etc., and may also be referred to as a beneficiary or a ‘taker’, the substitute remitter is a party who remits, settles, or pays price for products, items, services, etc., and may be referred to as a substitute payer or a ‘giver“, and the substitute remittance/payment is assumed that the substitute remitter different from the buyer (remitter) bears at least a portion of a purchase amount according to the purchase of the remitter.

In addition, the reservation substitute remittance processing server 300 may be configured to generate and issue the reservation substitute remittance unit using the remittable amount and remittable time information by a reservation substitute remittance request and acceptance procedure of the remitter A terminal 100 and the plurality of substitute remitter B terminals 210 and 220. When issuing the reservation substitute remittance unit, it is not necessary to know a recipient or a place of purchase in advance, which increases the convenience of the user (the remitter), and the substitute remittance/payment is processed at a future time when a remittance or payment is required, which makes it possible to efficiently and systematically manage substitute remittance funds.

In addition, by integrating and managing a plurality of reservation substitute remittance unit, for example, by comparing and determining remittable amount and remittable time information of a reservation substitute remittance unit issued between the remitter A and the substitute remitter B1 and a reservation substitute remittance unit issued between the substitute remitter B1 and a substitute remitter C, the two reservation substitute remittance units may be combined to perform a substitute remittance between the remitter A and the substitute remitter C. Through such an efficient remittance/collection management, it is unnecessary to process a plurality of substitute remittances, and an effect of reducing a transfer fee may be obtained.

In addition, a family finance integration platform which expands a family finance communication range between family members and manages family finances efficiently by applying a reservation substitute remittance relationship between family members, and is also available for gift and inheritance by reserving a substitute remittance time to a future time may be provided.

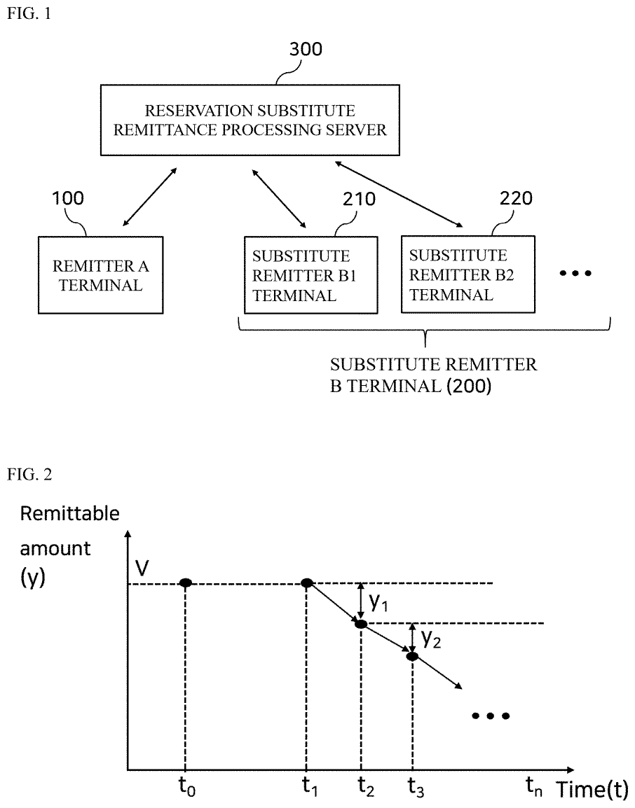

FIG. 2 is an example diagram illustrating an example of a substitute remittance processed based on a remittable amount and a remittable time according to an embodiment of the present disclosure.

Referring to FIG. 2, it is possible to check an occurrence and a change of a substitute remittable amount y on a time t axis. For example, in the case where a reservation substitute remittance unit is issued at a time t₀, and is set to have a start time to t₁ and an end time to tₙ as a substitute remittable time period, V set as a total substitute remittable amount may be activated as a total budget from the start time t₁ after the time to when the reservation substitute remittance unit is issued, when a substitute remittance is processed by an amount y₁ at a time t₂ after the start time t₁, may be changed as a remittable balance y=V−y₁, and when the substitute remittance is processed by an amount y₂ at a time t₃, may be changed as a remittable balance y=V −y₁−y₂.

In other words, the reservation substitute remittance unit may be set to have the start time and the end time as the time period in which the substitute remittance is activated and possible separately from an issuance time, and may be subtracted by the processed substitute remittance starting from the remittable amount set as the total budget during the set time period. Here, the start time or end time may be set not only as a specific date, but also as a time when a specific event or a specific condition occurs.

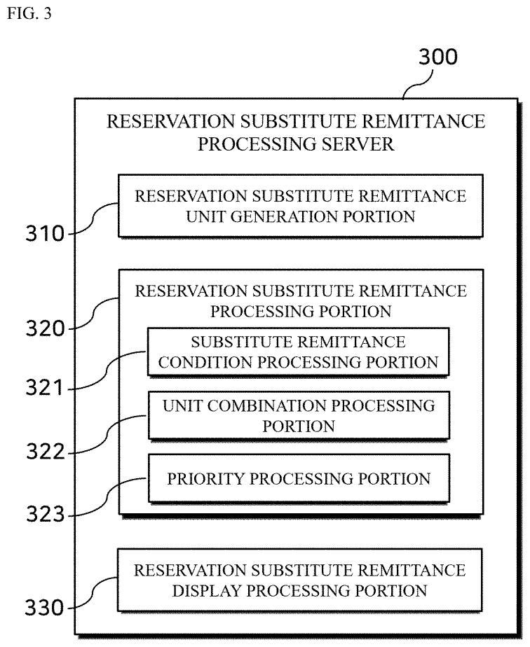

FIG. 3 is a block diagram illustrating a configuration of a reservation substitute remittance processing server according to an embodiment of the present disclosure.

The reservation substitute remittance processing server 300 may include a reservation substitute remittance unit generation portion 310, a reservation substitute remittance processing portion 320, and a reservation substitute remittance display processing portion 330. These components may include a program or a program module that may be executed by one or more processors. The program or program modules included in the reservation substitute remittance processing server 300 may be configured in the form of an operating system, an application program, or a program, and may be physically stored on various types of storage devices that are widely used. Such program or program modules may include various forms for performing one or more routines, subroutines, programs, objects, components, instructions, a data structure, and a specific task or for executing a specific data type, but is not limited to these types.

In addition, although not shown in FIG. 3, the reservation substitute remittance processing server 300 may include a communication portion for performing wired/wireless communication with a remitter terminal 100, a substitute remitter terminal 200, a card company server, a payer terminal, and a seller terminal.

The reservation substitute remittance processing server 300 may include the reservation substitute remittance unit generation portion 310 configured to generate a reservation substitute remittance unit based on identification information of a remitter and a substitute remitter, in response to a request from at least one of the remitter and the substitute remitter. The reservation substitute remittance unit generation portion 310 may generate the reservation substitute remittance unit based on the identification information of the remitter and the substitute remitter, and the reservation substitute remittance unit may include time period information in which a reservation substitute remittance is possible. The time period information may include start time condition information in which the reservation substitute remittance starts and end time condition information in which the reservation substitute remittance ends, and a start time or an end time may be set not only as a specific date, but also as a time when a specific event or a specific condition occurs. For example, the substitute remittance start time may be set as an issuance date of the reservation substitute remittance unit, one month after the issuance date, a specific date, or as a specific event or condition, a day when the age of the remitter turns 20, or a day when the KOSPI hits 2,500 points.

In addition, the reservation substitute remittance unit may include remittable budget information, and may update a current remittable amount by subtracting a substitute remittance amount used from the total remittable amount.

Here, information related to the time period information, the remittable budget information, or one-time usage limit of the reservation substitute remittance unit may be processed through, for example, a procedure of a request of the remitter and an approval of the substitute remitter, and to the contrary, may be processed only through a request of the substitute remitter.

In addition, the reservation substitute remittance processing portion 320 may include a substitute remittance condition processing portion 321, a unit combination processing portion 322, and a priority processing portion 323.

Here, the substitute remittance condition processing portion 321 may be configured to receive a remittance or payment request from the remitter, and process a substitute remittance or a substitute payment based on the remittable amount of the reservation substitute remittance unit. In addition, the substitute remittance condition processing portion 321 may be configured to determine whether a substitute remittance or substitute payment time satisfies the start time condition information. For example, when the substitute remittance or substitute payment time is after issuance of the reservation substitute remittance unit but before the start time, substitute payment processing may be rejected.

In addition, the substitute remittance condition processing portion 321 may manage the remittable amount of the reservation substitute remittance unit by subtracting an amount on which the substitute remittance or the substitute payment is processed from initially set total budget information. As shown in FIG. 2, the remittable amount is subtracted each time the substitute remittance is processed, and when a substitute remittance or payment request amount is greater than the remittable amount, the substitute remittance or payment may be processed only by the remaining balance.

Next, the unit combination processing portion 322 may be configured to integrate and manage a plurality of reservation substitute remittance units, for example, compare remitter information of a first reservation substitute remittance unit issued between the remitter A and the substitute remitter B1 with remitter information of a second reservation substitute remittance unit issued between the remitter B1 and the substitute remitter C, if the remitter information are the same, compare remittable amount and remittable time information, and combine the two reservation substitute remittance units so that the substitute remittance or payment may be performed between the remitter A and the substitute remitter C who are not a direct substitute remittance relationship.

In addition, as a means of the substitute remittance, the substitute remitter B1 may select one of a credit card, a bank account, or a reservation substitute remittance unit in which the substitute remitter B1 is issued as a remitter to process the substitute remittance. At this time, only the reservation substitute remittance unit that is effectively processable through the unit combination processing portion 322 may be displayed to the substitute remitter B1 as a processable means.

The priority processing portion 323 may be configured to set and process an application priority of a credit card, a bank account, the reservation substitute remittance unit, etc., as a substitute remittance means, when a substitute remittance or payment is requested to the substitute remitter. For example, when the reservation substitute remittance unit, the credit card, and the bank account are sequentially set as first, second, and third priorities by the setting of the substitute remitter, the priority processing portion 323 may be configured to process the substitute remittance through the reservation substitute remittance unit if there is a reservation substitute remittance unit available as the substitute remittance, and to process the substitute remittance/payment of a whole amount or a partial amount with the credit card that is the second priority if there is no available reservation substitute remittance unit or a substitute remittance amount lacks. In addition, when a payment of the credit card that is the second priority is disabled or rejected due to exceeding the limit or canceling the card, the substitute remittance may be performed through the means of the bank account that is the third priority set as the next priority.

In addition, when there are a plurality of substitute remitters such as B1 and B2 as substitute remitters of the remitter A, the priority processing portion 323 may be configured to set and process priorities between the substitute remitters by setting the remitter or the substitute remitters. For example, the priority processing portion 323 may set priorities between the substitute remitters so that when there are B1 and B2 set as the substitute remitters as the remitter, and when B1 is set as a first priority substitute remitter and B1 is set as a second priority substitute remitter, a substitute remittance of the first priority substitute remitter first proceeds, and when a substitute remittance of the substitute remitter B1 is impossible, or when a substitute remittance amount lacks, a substitute remittance of the substitute remitter B2 that is the next priority proceeds.

Lastly, the reservation substitute remittance display processing portion 330 may be configured to reflect results of processing the substitute remittance or the substitute payment to the reservation substitute remittance unit to update and provide related information to the user. For example, the reservation substitute remittance display processing portion 330 may update and display a plurality of reservation substitute remittance unit information issued to a user terminal, for example, remitter and substitute remitter identification information, and information about an issuance time, a start time and an end time, the remaining date if the end is not short, a whole substitute remittance budget, a current remittable amount, one-time usage limit, etc. through a reservation substitute remittance app.

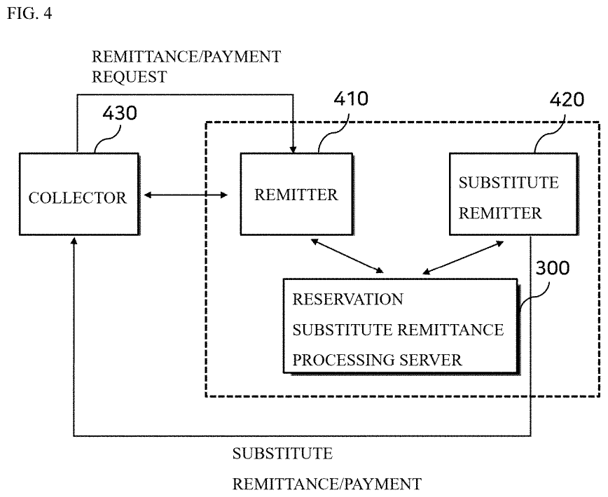

FIG. 4 is a conceptual diagram illustrating a method of processing a reservation substitute remittance/payment according to an embodiment of the present disclosure.

First, with regard to an inside of a square indicated in the dotted line, a reservation substitute remittance unit may be generated and issued through the reservation substitute remittance processing server 300 between a remitter 410 and a substitute remitter 420. At this time, the reservation substitute remittance unit is executed in a capital call method, and thus it is unnecessary to provide a substitute remittance amount to the remitter in advance at an issuance time of the reservation substitute remittance unit, and a substitute remittance is processed by a substitute remittance request at a future time when a substitute remittance or payment is required, thereby enabling an efficient fund management.

In addition, the reservation substitute remittance unit is set in a blind method, and thus information about a collector having a remittance or payment benefit of the remitter 410 in addition to the remitter 410 and the substitute remitter 420 is not requested and is not necessarily known at the issuance time. Accordingly, the user convenience of the remitter 410 is increased, and the substitute remitter 420 sets only conditions such as remittable budget information and time period information when issuing the reservation substitute remittance unit, thereby obtaining an effect of enabling systematic and efficient fund management.

If the start time passes after issuance of the reservation substitute remittance unit, the remitter 410 may request the remittance/payment with respect to a collector 430 for substitute remittance processing, and may proceed substitute remittance or payment processing according to a preset method when substitute remittance processing is valid based on whether the remittable amount and the time period conditions are satisfied through the reservation substitute remittance processing server 300.

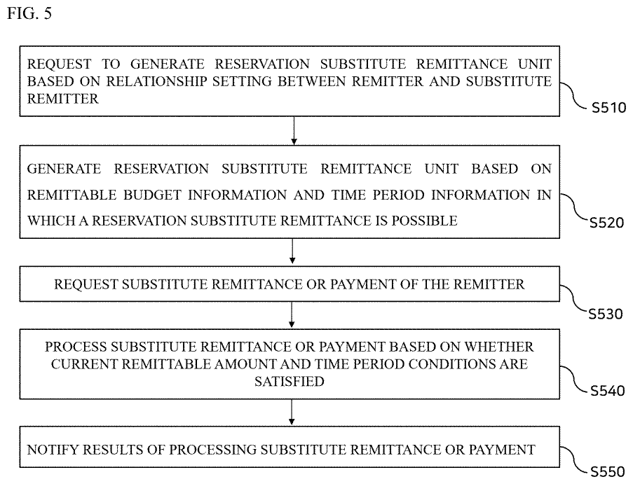

FIG. 5 is a flowchart illustrating a method of processing a reservation substitute remittance according to an embodiment of the present disclosure.

Referring to FIG. 5, a request for generating a reservation substitute remittance unit may be received in the reservation substitute remittance processing server 300 based on a substitute remittance relationship setting between a remitter and a substitute remitter (S510). Generating the reservation substitute remittance unit may be requested through a remitter terminal 100 or a substitute remitter terminal 200. At this time, identification information of the remitter and the substitute remitter must be received together.

The reservation substitute remittance processing server 300 may generate the reservation substitute remittance unit based on remittable budget information and time period information in which a reservation substitute remittance is possible (S520). Here, the time period information may include start time condition information in which the reservation substitute remittance starts.

After issuance of the reservation substitute remittance unit, a substitute remittance or payment request of the remitter may be received (S530).

The reservation substitute remittance processing server 300 may determine whether current remittable amount and time period conditions of the reservation substitute remittance unit are satisfied, and when the conditions are satisfied, process a substitute remittance or payment (S540).

After processing the substitute remittance or payment, the reservation substitute remittance processing server 300 may transfer results of processing the substitute remittance or payment to the remitter terminal 100 and a substitute remitter terminal 200 as a notification (S550). The remitter and the substitute remitter may also check updated information of the reservation substitute remittance unit, for example, the current remittable amount, the remaining date of a substitute remittable period, a currently valid reservation substitute remittance unit through terminals of the remitter and the substitute remitter.

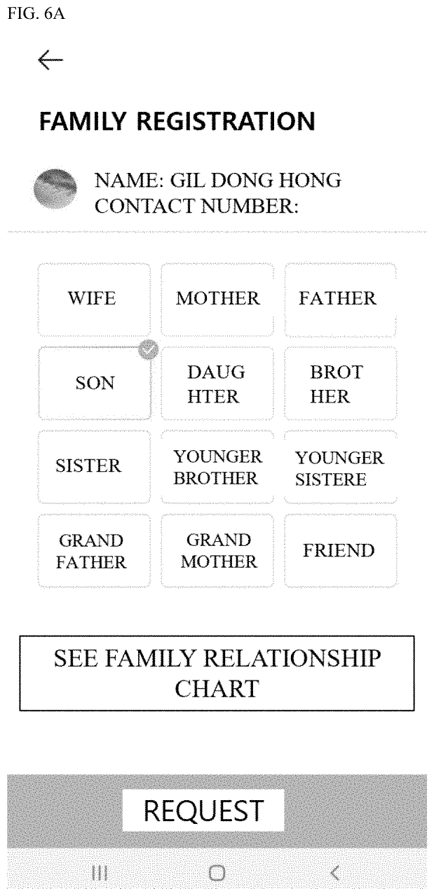

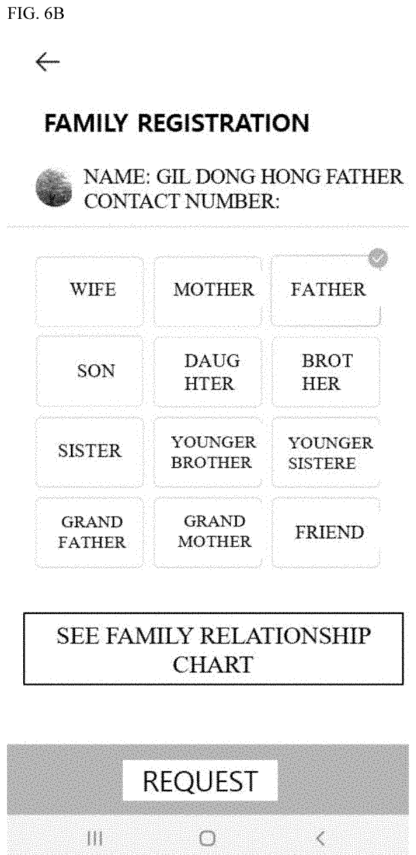

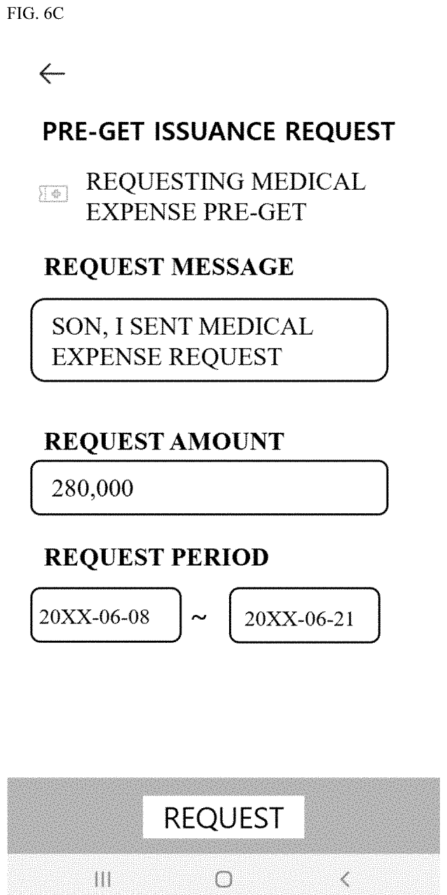

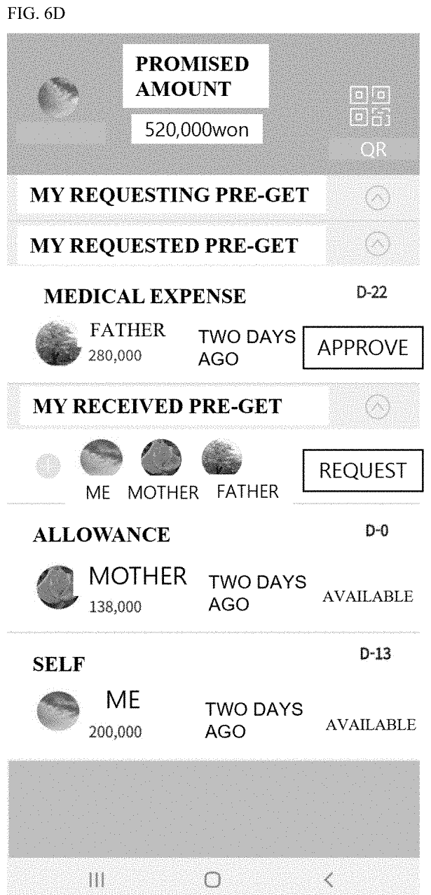

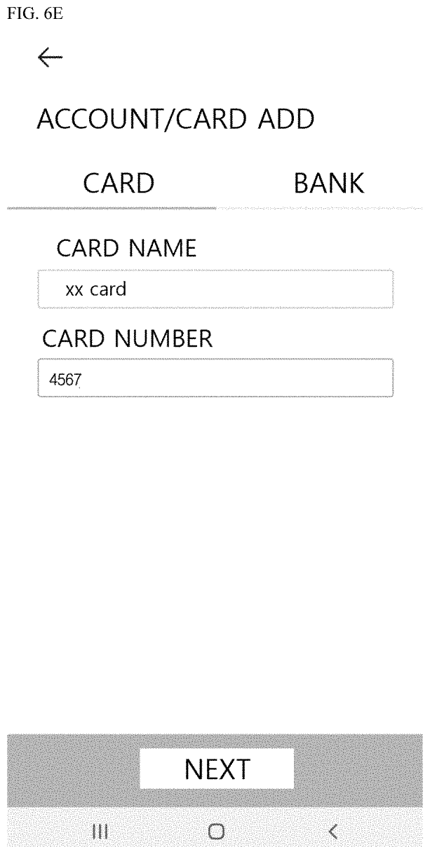

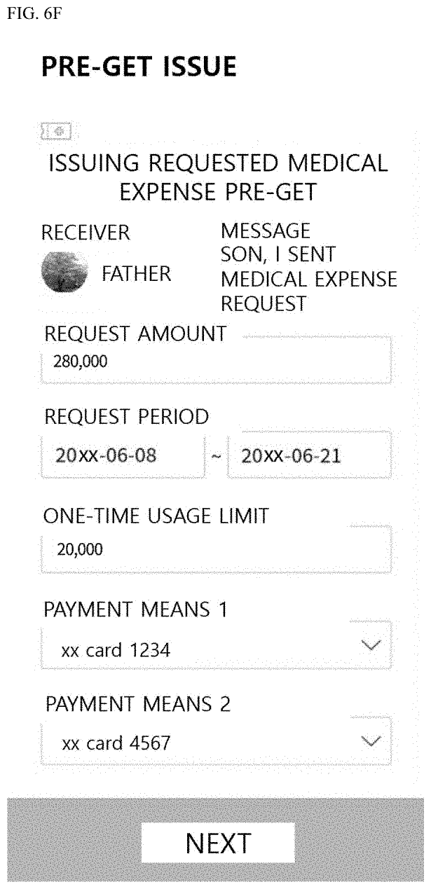

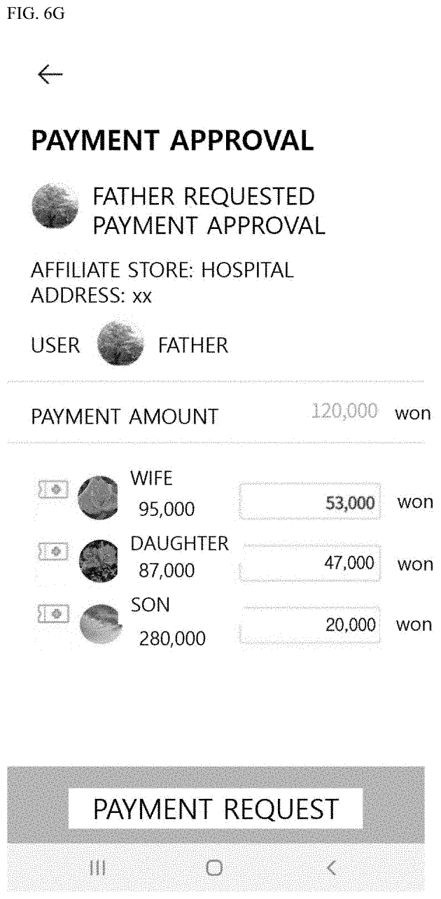

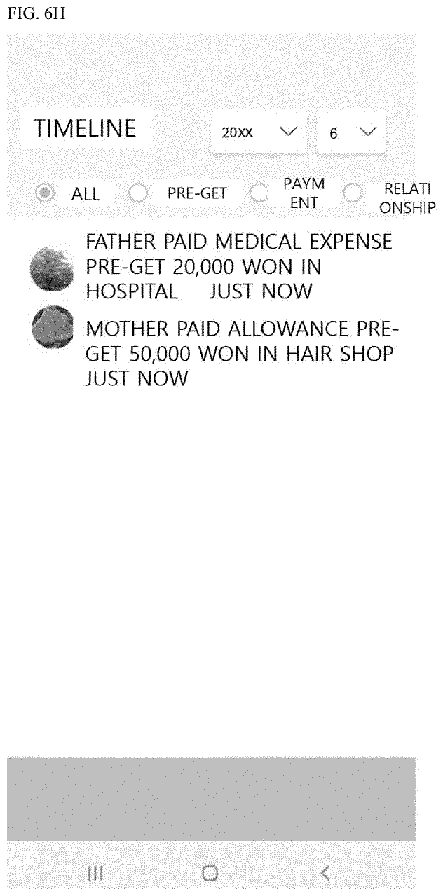

FIGS. 6A to 6H are example diagrams illustrating a processing process in an app for reservation substitute remittance processing according to an embodiment of the present disclosure.

FIGS. 6A and 6B are examples of a relationship between a remitter and a substitute remitter, and show setting of the relationship between the remitter and the substitute remitter through a family registration. Referring to FIG. 6A, a son is requested as the substitute remitter based on the family relationship, and referring to FIG. 6B, the son approves a father based on the family relationship to complete the setting as the substitute remitter.

Referring to FIG. 6C, the father (the remitter) sends a pre-get issuance request message to the son (the substitute remitter) to generate a reservation substitute remittance unit, and at this time, the request message, a request amount, and a request period may be delivered together. The request amount and the request time set as described above may be included in the reservation substitute remittance unit respectively as remittable budget information and time period information.

Referring to FIG. 6D, the son who receives the pre-get issuance request message may confirm a request to generate the reservation substitute remittance unit as the substitute remitter, and press an approve button to approve the request so that the reservation substitute remittance unit is generated.

Referring to FIG. 6E, as a means of a substitute remittance of the corresponding reservation substitute remittance unit, means such as an account/card and related information may be input and set. Referring to FIG. 6F, identification information of a recipient as the remitter is displayed, and a pre-get including information such as a request amount, a request period, one-time usage limit, a payment method, etc. is issued, so that the reservation substitute remittance unit may be finally issued.

Referring to FIG. 6G, the remitter may process a substitute remittance/payment approval request, and process and request a split payment of a payment amount from a plurality of substitute remitters, such as a wife, daughter, and son. For example, when one-time usage limit of the son who is the substitute remitter is 20,000 won, a substitute payment amount of the son may be input as 20,000 won in the total payment amount, and the remaining amount may be appropriately split and distributed to other substitute remitters.

Referring to FIG. 6H, according to payment processing of the father, a substitute payment situation may be displayed through a substitute remitter terminal in the form of a timeline, and various reservation substitute remittance unit information may be retrieved and checked according to conditions.

As described above, the reservation substitute remittance processing system according to the present disclosure is applied to setting of relationships between family members, thereby expanding a family finance communication range, efficiently managing family finance, and in particular managing funds to be executed at a future time, and thus the reservation substitute remittance processing system has the advantage that can be used for gift and inheritance.

In the above, the reservation substitute remittance processing system and method according to the embodiments of the present disclosure have been described as specific various embodiments, but this is only an example, and the present disclosure is not limited thereto, and should be construed as having the widest scope according to the basic idea disclosed herein. Those skilled in the art may combine and replace the disclosed embodiments to implement a pattern having a shape that is not indicated, but this also does not depart from the scope of the present disclosure. In addition, those skilled in the art may easily change or modify the disclosed embodiments based on the present specification, and it is clear that such changes or modifications also belong to the scope of the present disclosure.

What is claimed is:

1. A reservation substitute remittance method using a reservation substitute remittance processing server, the reservation substitute remittance method comprising:
receiving a request from at least one of a remitter and a substitute remitter to generate a reservation substitute remittance unit;
generating the reservation substitute remittance unit based on identification information of the remitter and the substitute remitter;
receiving a remittance or payment request from the remitter;
processing a substitute remittance or a substitute payment based on a remittable amount of the reservation substitute remittance unit; and
reflecting results of processing the substitute remittance or the substitute payment to the reservation substitute remittance unit.

2. The reservation substitute remittance method of claim 1, wherein the reservation substitute remittance unit comprises time period information in which a reservation substitute remittance is allowed.

3. The reservation substitute remittance method of claim 2, wherein the reservation substitute remittance unit comprises start time condition information in which the reservation substitute remittance starts, and wherein the processing of the substitute remittance or the substitute payment comprises determining whether a substitute remittance or substitute payment time satisfies the start time condition information.

4. The reservation substitute remittance method of claim 1, wherein the reservation substitute remittance unit comprises total budget information in which a reservation substitute remittance is allowed, and the remittable amount of the reservation substitute remittance unit is obtained by subtracting, from the total budget information, an amount on which the substitute remittance or the substitute payment is processed.

5. The reservation substitute remittance method of claim 1, wherein the reservation substitute remittance unit comprises a first reservation substitute remittance unit and a second reservation substitute remittance unit, and
further comprising processing the substitute remittance or the substitute payment by combining the first reservation substitute remittance unit and the second reservation substitute remittance unit, based on whether substitute remitter information of the first reservation substitute remittance unit and remitter information of the second reservation substitute remittance unit are the same.

6. The reservation substitute remittance method of claim 5, further comprising comparing and determining a substitute remittance or substitute payment time with time period information of the first reservation substitute remittance unit in which a reservation substitute remittance is allowed and time period information of the second reservation substitute remittance unit in which a reservation substitute remittance is allowed.

7. A reservation substitute remittance processing server for processing a reservation substitute remittance, the reservation substitute remittance processing server comprising:
a reservation substitute remittance unit generation portion configured to generate a reservation substitute remittance unit, in response to a request from at least one of a remitter and a substitute remitter, based on identification information of the remitter and the substitute remitter;
a substitute remittance condition processing portion configured to receive a remittance or payment request from the remitter and process a substitute remittance or a substitute payment based on a remittable amount of the reservation substitute remittance unit; and
a reservation substitute remittance display processing portion configured to reflect results of processing the substitute remittance or the substitute payment to the reservation substitute remittance unit and provide the reservation substitute remittance unit to a user.

8. The reservation substitute remittance processing server of claim 7, wherein the reservation substitute remittance unit comprises time period information in which a reservation substitute remittance is allowed.

9. The reservation substitute remittance processing server of claim 8, wherein the reservation substitute remittance unit comprises start time condition information in which the reservation substitute remittance starts, and wherein the substitute remittance condition processing portion is configured to determine whether a substitute remittance or substitute payment time satisfies the start time condition information.

10. The reservation substitute remittance processing server of claim 7, wherein the reservation substitute remittance unit comprises total budget information in which a reservation substitute remittance is allowed, and the remittable amount of the reservation substitute remittance unit is obtained by subtracting an amount on which the substitute remittance or the substitute payment is processed from the total budget information.

11. The reservation substitute remittance processing server of claim 7, wherein the reservation substitute remittance unit comprises a first reservation substitute remittance unit and a second reservation substitute remittance unit, and
further comprising: a unit combination processing portion configured to process the substitute remittance or the substitute payment by combining the first reservation substitute remittance unit and the second reservation substitute remittance unit based on whether substitute remitter information of the first reservation substitute remittance unit and remitter information of the second reservation substitute remittance unit are the same.

12. The reservation substitute remittance processing server of claim 11, wherein the unit combination processing portion is configured to compare and determine a substitute remittance or substitute payment time with time period information of the first reservation substitute remittance unit in which a reservation substitute remittance is allowed and time period information of the second reservation substitute remittance unit in which a reservation substitute remittance is allowed.
